(19) United States
(12) Patent Application Publication
(10) Pub. No.: US 2025/0209090 A1
(43) Pub. Date: Jun. 26, 2025

(54) GRAPH DATA PARTITIONING METHODS AND APPARATUSES

(71) Applicant: Alipay (Hangzhou) Information Technology Co., Ltd., Hangzhou (CN)

(72) Inventors: Mingyao Li, Hangzhou (CN); Likang Chen, Hangzhou (CN)

(73) Assignee: Alipay (Hangzhou) Information Technology Co., Ltd., Hangzhou (CN)

(21) Appl. No.: 18/946,421

(22) Filed: Nov. 13, 2024

(30) Foreign Application Priority Data
Dec. 22, 2023 (CN) 202311786159.6

(51) Int. Cl. G06F 16/27; G06F 16/901

(52) U.S. Cl. CPC G06F 16/278; G06F 16/9024

(57) ABSTRACT

Method, apparatus and computer-readable media are provided. During graph data partitioning, graph nodes in graph data are partitioned based on degrees of the graph nodes according to a computing load balancing allocation algorithm, such that the graph nodes are partitioned as primary graph nodes into graph data partitions. Subsequently, edge data of associated edges of the primary graph nodes are allocated to corresponding graph data partitions, where the associated edges include outgoing edges and/or incoming edges. Additionally, for an associated edge of a primary graph node, a replica of another graph node that corresponds to the primary graph node for the associated edges is constructed to be stored as a mirror graph node in the graph data partition corresponding to the primary graph node.

### CROSS-REFERENCE TO RELATED APPLICATIONS

This application claims priority to Chinese Patent Application No. 202311786159.6, filed on Dec. 22, 2023, which is hereby incorporated by reference in its entirety.

### TECHNICAL FIELD

Embodiments of this specification generally relate to the field of graph databases, and in particular, to graph data partitioning methods and apparatuses.

### BACKGROUND

Graph data is composed of nodes (vertices) and edges, where the nodes represent entities and the edges represent relationships between the entities. For example, in social graph data, each person represents one node, and relationships (e.g., friends, families, colleagues, etc.) form edges. As increasingly more entities and relationships are involved in an application scenario, a scale of graph data becomes increasingly larger. The analysis of large-scale graph data requires a huge computing capability, and a conventional single-machine graph computing scheme cannot meet a requirement. As a scheme, distributed graph computing allows graph data and computing tasks to be distributed across a plurality of computing nodes to implement large-scale processing and improve computing efficiency. The challenge for distributed graph computing is how to efficiently partition graph data among a plurality of computing nodes.

### SUMMARY

Embodiments of this specification provide a method and apparatus for graph data partitioning. By using this graph data partitioning scheme, graph data partitioning is performed by combining the partitioning of graph nodes with the allocation of edge data based on the partitioned graph nodes. Additionally, replicas of graph nodes that form edge relationships with the partitioned graph nodes are added to the partitioned graph data as mirror graph nodes. This allows for efficient graph data partitioning across a plurality of computing nodes while reducing the communication costs across partitions during graph computations based on the partitioned graph data.

According to an aspect of one or more embodiments of this specification, a graph data partitioning method is provided, including the following: partitioning graph nodes in graph data based on degrees of the graph nodes according to a computing load balancing allocation algorithm, such that the graph nodes are partitioned as primary graph nodes into graph data partitions; allocating edge data of associated edges of the primary graph nodes to corresponding graph data partitions, where the associated edges include outgoing edges and/or incoming edges; and for an associated edge of a primary graph node, constructing a replica of another graph node that corresponds to the primary graph node for the associated edge to be stored as a mirror graph node in a graph data partition corresponding to the primary graph node.

Optionally, in an example of the above-mentioned aspect, the allocating edge data of the associated edges of the primary graph nodes to the corresponding graph data partitions can include the following: allocating edge data of the associated edges of the primary graph nodes to the corresponding graph data partitions according to an associated edge allocation strategy, where the associated edge allocation strategy includes one of an outgoing edge allocation strategy, an incoming edge allocation strategy, or a combined outgoing edge/incoming edge allocation strategy.

Optionally, in an example of the above-mentioned aspect, the associated edge allocation strategy is determined according to a graph data acquisition strategy of a downstream graph computing task.

Optionally, in an example of the above-mentioned aspect, the allocating edge data of the associated edges of the primary graph nodes to the corresponding graph data partitions can include the following: obtaining edge data of the associated edges from an edge list of the graph data based on edge list offsets of the associated edges; and allocating the obtained edge data of the associated edges to the corresponding graph data partitions.

Optionally, in an example of the above-mentioned aspect, the edge data is stored in the edge list in an order of node numbers of corresponding graph nodes, and the edge list offsets of the associated edges are determined based on out-degrees of the graph nodes.

Optionally, in an example of the above-mentioned aspect, the graph data partitioning method can further include the following: allocating local node identifiers and global node identifiers to the primary graph node in the graph data partition and the mirror graph node; and/or establishing a node mapping relationship between the mirror graph node and a corresponding primary graph node in another graph data partition.

Optionally, in an example of the above-mentioned aspect, an edge list of the edge data is in a format of a sparse adjacency list.

Optionally, in an example of the above-mentioned aspect, the graph data partitioning method can further include the following: generating partition offset information for the graph data partition and storing the partition offset information in the graph data partition, where the partition offset information includes the number of the primary graph nodes in the graph data partition.

According to another aspect of one or more embodiments of this specification, a graph data partitioning apparatus is provided, including the following: a graph node partitioning unit that partitions graph nodes in graph data based on degrees of the graph nodes according to a computing load balancing allocation algorithm, such that the graph nodes are partitioned as primary graph nodes into graph data partitions; an edge data allocation unit that allocates edge data of associated edges of the primary graph nodes to corresponding graph data partitions, where the associated edges include outgoing edges and/or incoming edges; and a mirror graph node construction unit that constructs, for an associated edge of a primary graph node, a replica of another graph node that corresponds to the primary graph node for the associated edge to be stored as a mirror graph node in a graph data partition corresponding to the primary graph node.

Optionally, in an example of the above-mentioned aspect, the edge data allocation unit allocates edge data of the associated edges of the primary graph nodes to the corresponding graph data partitions according to an associated edge allocation strategy, where the associated edge allocation strategy includes one of an outgoing edge allocation strategy, an incoming edge allocation strategy, or a combined outgoing edge/incoming edge allocation strategy.

Optionally, in an example of the above-mentioned aspect, the edge data allocation unit can include the following: an edge data acquisition module that obtains edge data of the associated edges from an edge list of the graph data based on edge list offsets of the associated edges; and an edge data allocation module that allocates the obtained edge data of the associated edges to the corresponding graph data partitions.

Optionally, in an example of the above-mentioned aspect, the graph data partitioning apparatus can further include the following: a node identifier allocation unit that allocates a local node identifier and a global node identifier to the primary graph nodes in the graph data partitions and the mirror graph nodes; and/or a node mapping relationship establishment unit that establishes a node mapping relationship between the mirror graph node and the corresponding primary graph node in another graph data partition.

Optionally, in an example of the above-mentioned aspect, the graph data partitioning apparatus can further include the following: a partition offset information generation unit that generates partition offset information for the graph data partition and storing the partition offset information in the graph data partition, where the partition offset information includes the number of the primary graph nodes in the graph data partition.

According to another aspect of one or more embodiments of this specification, a graph data partitioning apparatus is provided, including the following: at least one processor; a storage coupled to the at least one processor; and a computer program stored in the storage. The at least one processor executes the computer program to implement the above-mentioned graph data partitioning method.

### BRIEF DESCRIPTION OF DRAWINGS

The essence and advantages of the content of this specification can be further understood by referring to the following accompanying drawings. In the accompanying drawings, similar components or features can have the same reference numerals.

FIG. 1 is an example schematic diagram illustrating a distributed graph computing system, according to one or more embodiments of this specification;

FIG. 2 is an example flowchart illustrating a graph data partitioning method, according to one or more embodiments of this specification;

FIG. 3 is an example schematic diagram illustrating a data storage structure of graph data, according to one or more embodiments of this specification;

FIG. 4 is an example schematic diagram illustrating a graph data structure, according to one or more embodiments of this specification;

FIG. 5 is an example flowchart illustrating an edge data allocation process, according to one or more embodiments of this specification;

FIG. 6 is an example schematic diagram illustrating an associated edge allocation strategy, according to one or more embodiments of this specification;

FIG. 7 is an example schematic diagram illustrating a format of a sparse adjacency list, according to one or more embodiments of this specification;

FIG. 8 is an example block diagram illustrating a graph data partitioning apparatus, according to one or more embodiments of this specification;

FIG. 9 is an example block diagram of an edge data allocation unit, according to one or more embodiments of this specification; and

FIG. 10 is an example schematic diagram illustrating a graph data partitioning apparatus implemented based on a computer system, according to one or more embodiments of this specification.

### DETAILED DESCRIPTION

The subject matters described in this specification are discussed below with reference to example implementations. It should be understood that the discussion of these implementations is merely intended to enable a person skilled in the art to better understand the subject matters described in this specification, and is not intended to limit the protection scope, applicability, or examples described in the claims. The functions and arrangements of the elements under discussion can be changed without departing from the protection scope of this specification. Various processes or components can be omitted, replaced, or added in various examples as needed. For example, the described method can be performed in a sequence different from the described sequence, and the steps can be added, omitted, or combined. Additionally, the features described in some examples can also be combined in other examples.

As used in this specification, the term “include” and variants thereof represent an open term, which means “including but not limited to”. The term “based on” represents “at least partially based on”. The term “some embodiments” represents “at least one embodiment”. The term “some other embodiments” represents “at least one other embodiment”. The terms “first”, “second”, etc. can refer to different or identical objects. Other definitions, whether explicit or implicit, can be included below. Unless expressly specified in the context, the definition of a term is consistent throughout this specification.

A flowchart used in this specification illustrates operations implemented by a system according to some embodiments of this specification. It should be clearly understood that operations in the flowchart may not be implemented in sequence. In contrast, the operations can be implemented in reverse order or simultaneously. Additionally, one or more other operations can be added to the flowchart. One or more operations can be removed from the flowchart.

Graph data partitioning methods and apparatuses according to one or more embodiments of this specification are described below with reference to the accompanying drawings.

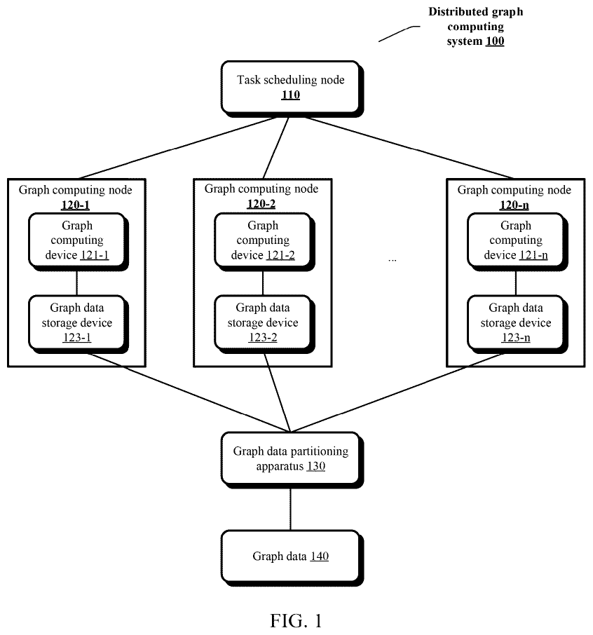

FIG. 1 is an example schematic diagram illustrating a distributed graph computing system 100, according to one or more embodiments of this specification.

As shown in FIG. 1, the distributed graph computing system 100 includes a task scheduling node 110, graph computing nodes 120-1 to 120-n, and a graph data partitioning apparatus 130. The task scheduling node 110 is configured to: after receiving a graph computing task, decompose the graph computing task into a plurality of graph computing sub-tasks, and deliver each graph computing sub-task to a corresponding graph computing node 120 to perform graph computing.

The graph computing nodes 120-1 to 120-n form a distributed graph computing architecture, and are configured to implement distributed computing of the graph computing task. Each graph computing node can include a graph computing device and a graph data storage device. The graph data storage device on each graph computing node is configured to store a graph data partition (which can also be referred to as a graph data shard) obtained after graph data is partitioned by the graph data partitioning apparatus 130. The graph computing device is configured to obtain, from graph data partitions stored in a local graph data storage device, graph data required by the graph computing sub-task, to perform graph computing processing.

Components in the task scheduling node 110, the graph computing nodes 120-1 to 120-n, and the graph data partitioning apparatus 130 can communicate directly or through a network. In some embodiments, the network can be any one or more of a wired network or a wireless network. Examples of the network can include a cable network, a fiber-optic network, a telecommunication network, an enterprise internal network, the Internet, a local area network (LAN), a wide area network (WAN), a wireless local area network (WLAN), a metropolitan area network (MAN), a public switched telephone network (PSTN), a Bluetooth network, a ZigBee network, near field communication (NFC), an intra-device bus, an intra-device line, etc., or any combination thereof.

FIG. 2 is an example flowchart illustrating a graph data partitioning method 200, according to one or more embodiments of this specification.

As shown in FIG. 2, in step 210, graph nodes in graph data are partitioned based on degrees of the graph nodes according to a computing load balancing allocation algorithm, such that the graph nodes are partitioned as primary graph nodes into graph data partitions.

Graph data is composed of nodes (vertices) and edges, where the nodes represent entities and the edges represent relationships between the entities. For example, in social graph data, each person represents one node, and relationships (e.g., friends, families, colleagues, etc.) form edges.

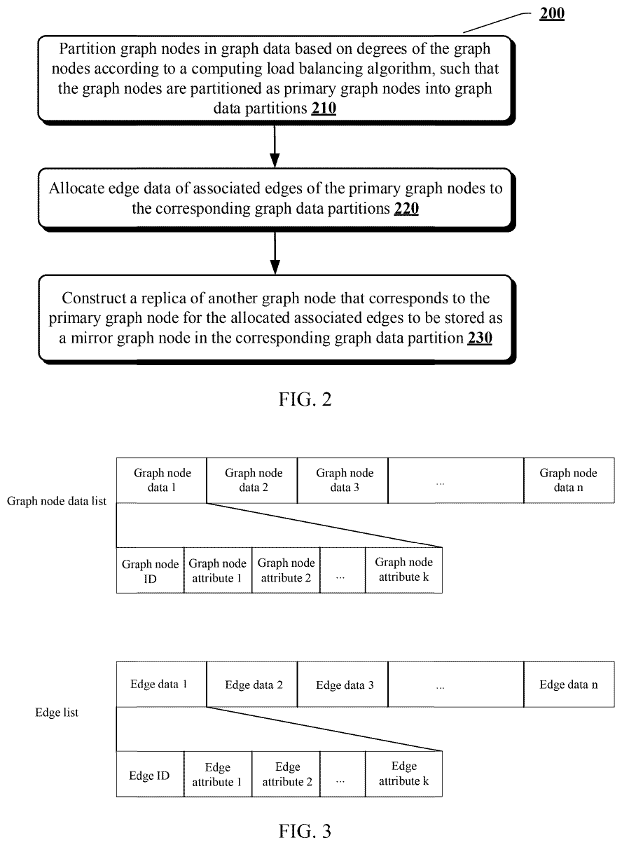

In some embodiments, graph nodes and edge data in the graph data are stored in a form of a graph node data list and an edge list, respectively. FIG. 3 is an example schematic diagram illustrating a data storage structure of graph data. In a graph node data list structure shown in FIG. 3, graph node data is stored in a graph node data list in sequence, and a storage location of each piece of graph node data in the graph node data list can be indexed by using a data storage index. For example, a data storage index of each graph node can be represented by a node offset of the graph node relative to a start graph node in the graph node data list. In some embodiments, the node offset can be represented by a difference between a node number (e.g., a local node identifiers) of the graph node and a node number of the start graph node. For example, if graph node 1 is the start graph node, a node offset of graph node 2 is 1, a node offset of graph node 3 is 2, and a node offset of graph node n is n-1. In some embodiments, the same storage size is allocated to all graph nodes. In this case, the node offset can be represented by a result obtained by multiplying the difference between the node number of the graph node and the node number of the start graph node by the allocated storage size.

In some embodiments, graph node data of each graph node can include, for example, a graph node ID and a graph node attribute. The graph node attribute can include one or more graph node attributes. For example, the graph node attributes can include node features. For example, when an entity corresponding to the graph node is a user, the node features can include the user's age, the user's gender, the user's address, the user's preference, etc. In some embodiments, the graph node attributes can further include a graph node degree used to indicate the number of edges of associated edges (an outgoing edge and an incoming edge) of the graph node, i.e., a sum obtained by adding an out-degree and an in-degree of the graph node. In some embodiments, the graph node attributes can further include the out-degree of the graph node and the in-degree of the graph node.

Similar to the graph node, edge data can be stored in an edge list in an order of node numbers of corresponding source graph nodes and target graph nodes, and a storage location of each piece of edge data in the edge list can be indexed by using an edge list index. For example, an edge list index of each piece of edge data can be represented by an edge list offset of an edge relative to a start edge in the edge list. In some embodiments, the edge list offset can be represented by a difference between an edge number (e.g., a local edge number) of the edge and an edge number of the first edge. For example, if edge 1 is the first edge, an edge list offset of edge 2 is 1, an edge list offset of edge 3 is 2, and an edge list offset of edge k is k-1. In some embodiments, if the same storage size is allocated to all edge data, the edge list offset can be represented by a result of multiplying the difference between the edge number of the edge and the edge number of the first edge by the allocated storage size.

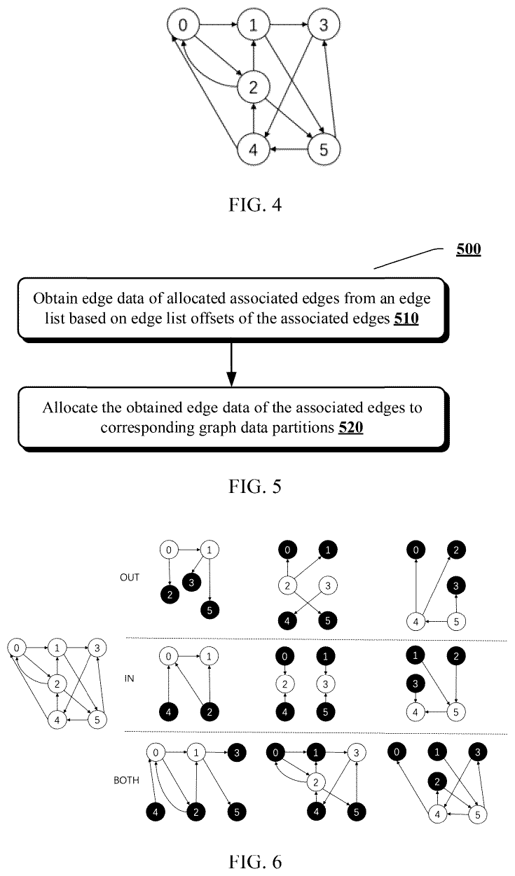

In some embodiments, out-degrees of graph nodes in the graph data are stored in an array. A storage location of a graph node in the array corresponds to a graph topology structure location of the graph node in the graph data structure, and an out-degree of the graph node is stored on the storage location. For example, for graph data shown in FIG. 4, out-degrees of graph nodes are stored as (2, 2, 3, 1, 2, 2), where storage locations of out-degrees of nodes in this array can be sequentially allocated based on node numbers of the graph nodes, i.e., the first location in the array corresponds to graph node 0, the second location corresponds to graph node 1, . . . , and the sixth location corresponds to graph node 5. In this case, an edge list offset of outgoing edge data can be determined based on the out-degrees of the graph nodes in the graph data. For example, for an edge that uses graph node 3 as a source graph node and graph node 4 as a target graph node, out-degrees of graph node 0, graph node 1, and graph node 2 are 2, 2, and 3, respectively. Therefore, based on the out-degrees of graph node 0, graph node 1, and graph node 2, it can be determined that a start edge list offset of edge data that uses graph node 3 as a source graph node is 7. Because there is only one edge that uses graph node 3 as a source graph node, an edge list offset of edge data of this edge is the corresponding start edge offset, that is, 7. If the source graph node of the edge has a plurality of edges, an edge, e.g., a kth edge, that the edge belongs to in the plurality of edges corresponding to the source graph node is determined, and k-1 is added to a start edge list offset n, to obtain an edge list offset of edge data of the edge.

In some embodiments, the determined edge list offset of the edge data can be stored in an edge list offset table for query during allocation of edge data. In some embodiments, an edge list offset of edge data can be determined in real time based on the out-degree of the graph node in the above-mentioned manner during allocation of the edge data. For example, the edge list offset of the edge data can be determined based on the out-degree of the graph node and a graph topology structure of the graph data.

In some embodiments, the graph nodes can be partitioned based on the out-degrees of the graph nodes according to a greedy allocation algorithm. For example, in some examples, a degree of each graph node can be calculated based on the graph topology structure of the graph data. In some examples, the degree of each graph node can be determined based on an edge list of the graph data. Then, nodes are greedily allocated to different graph data partitions based on their degrees. A greedy allocation process can be performed cyclically. During each greedy allocation, a vertex with a higher degree of node in an unallocated graph node is taken into consideration first, and after each greedy allocation is completed, the number of edges in all graph data partitions is balanced as much as possible.

In some examples, an empirical value alpha (e.g., alpha=4) is also taken into consideration during greedy allocation, i.e., greedy allocation is performed based on the degree of the graph node and the empirical value alpha. An alpha value is used to play a regulating function during calculation of the number of edges to which each graph data partition should be allocated, to add a certain redundancy during allocation of edges, thereby balancing computing load at computing nodes and improving computing efficiency. For example, a parameter alpha*num_vertices, i.e., alpha multiplied by a sum of the number of vertices, can be used, and the parameter is added to indication information num_remaining_edges used to indicate the number of remaining edges of the graph data partition. With this parameter, additional edge space can be reserved for each primary graph node in the graph data partition, thereby making graph node partitioning more flexible, and reducing load imbalance caused by uneven distribution of vertex degrees.

Additionally, each time after greedy allocation is completed, the alpha value can be further added to the number of allocated edges as the number of allocated edges of a current graph data partition that undergoes greedy allocation. This operation can be helpful in ensuring that during greedy allocation based on the degree of node, considering that an edge of each graph data partition should have certain flowing space, the graph data partition is prevented from being allocated too much edge data due to a very large sum of degrees of nodes.

Return to FIG. 2. In step 220, edge data of associated edges of the primary graph nodes is allocated to corresponding graph data partitions. The associated edges can include, for example, outgoing edges and/or incoming edges. An outgoing edge of a primary graph node represents an edge that uses the primary graph node as a source graph node, and an outgoing edge of the primary graph node represents an edge that uses the primary graph node as a target graph node.

FIG. 5 is an example flowchart illustrating an edge data allocation process 500, according to one or more embodiments of this specification.

As shown in FIG. 5, in step 510, edge data of associated edges of primary graph nodes is obtained from an edge list of graph data based on edge list offsets of the associated edges. In some embodiments, the edge list offsets of the associated edges can be queried from an edge list offset table. In some embodiments, the edge list offsets of the associated edges can be determined in real time based on an out-degrees of graph nodes.

In step 520, the obtained edge data of the associated edges is allocated to corresponding graph data partitions.

In some embodiments, the edge data of the associated edges of the primary graph nodes is allocated to the corresponding graph data partitions according to an associated edge allocation strategy. The associated edge allocation strategy can include, for example, one of an outgoing edge allocation strategy, an incoming edge allocation strategy, or a combined outgoing edge/incoming edge combined allocation strategy. The outgoing edge allocation strategy is used to instruct to allocate all outgoing edges of the primary graph nodes to graph data partitions corresponding to the primary graph nodes. The incoming edge allocation strategy is used to instruct to allocate all incoming edges of the primary graph nodes to the graph data partitions corresponding to the primary graph nodes. The combined outgoing edge/incoming edge allocation strategy is used to instruct to allocate all outgoing edges and incoming edges of the primary graph nodes to the graph data partitions corresponding to the primary graph nodes. FIG. 6 is an example schematic diagram illustrating an associated edge allocation strategy, according to one or more embodiments of this specification.

In some embodiments, the associated edge allocation strategy can be determined according to a graph data acquisition strategy of a downstream graph computing task. Examples of the graph computing task can include, but are not limited to, path query, community discovery, importance analysis, relevance analysis, graph structure analysis, etc. During execution of the graph computing task, if a used graph data acquisition path direction of the graph data is from a source graph node of an edge to a target graph node, for example, to query a neighbor graph node of a graph node, the outgoing edge allocation strategy is selected for allocating an associated edge. If the used graph data acquisition path direction of the graph data is from the target graph node of the edge to the source graph node, for example, for computing of neighbor graph node information aggregation for a graph node, node data of neighbor graph nodes need to be aggregated to the graph node, and thus, the incoming edge allocation strategy needs to be selected for allocating an associated edge. If the used graph data acquisition path direction of the graph data is bidirectional flowing from the source graph node to the target graph node, the combined outgoing edge/incoming edge allocation strategy needs to be selected for allocating an associated edge.

After the allocation of the associated edge is completed as described above, in step 230, for an associated edge of a primary graph node, a replica of another graph node that corresponds to the primary graph node for the associated edge is constructed to be stored as a mirror graph node in a graph data partition corresponding to the primary graph node, e.g., a graph node shown in a black circle in FIG. 6.

In the above-mentioned graph data partitioning scheme, the primary graph nodes are partitioned through block partitioning by using a computing load balancing allocation algorithm, and edge data is allocated based on the primary graph nodes. Thus, it can be ensured that the number of edges in graph data partitions stored at all computing nodes is the same, thereby ensuring computing load balancing at the computing nodes, and implementing efficient graph data partitioning among a plurality of computing nodes. Additionally, in the graph data partition obtained through partitioning, replicas of graph nodes in the allocated edge data that form edge relationships with the partitioned graph nodes are further maintained as the mirror graph nodes, so that local features required for local graph computing that is located in another graph data partition are reserved in the graph data partition. Therefore, the communication across partitions is not required during graph computing, thereby reducing the communication costs across partitions.

In the above-mentioned graph data partitioning scheme, the associated edge allocation strategy is determined according to a graph data acquisition strategy of a downstream graph computing task, so that a graph data partition obtained through partitioning can be more suitable for the downstream graph computing task, thereby improving processing efficiency of the downstream graph computing task.

In some embodiments, during graph data partitioning, local node identifiers and global node identifiers can be further allocated to the primary graph node in the graph data partitions and the mirror graph node. In this manner, during local graph computing, nodes can be indexed by using the local node identifiers, so that node indexing efficiency can be improved, thereby improving local graph computing efficiency. Additionally, the global node identifiers can be used to synchronize data between different graph data partitions, thereby implementing data consistency between the graph data partitions.

In some embodiments, during graph data partitioning, a node mapping relationship can be further established between the mirror graph nodes and corresponding primary graph nodes in another graph data partition. Therefore, after local graph computing processing is completed, if node data of the mirror graph node changes, data synchronization with the corresponding primary graph nodes in the another graph data partition is implemented based on the established node mapping relationship. For example, a node mapping relationship can be established between the mirror graph nodes and the corresponding primary graph nodes in the another graph data partition by using the global node identifiers.

In some embodiments, in a graph data partition that completes graph data partitioning, an edge list of edge data can be stored in a format of a sparse adjacency list. FIG. 7 is an example schematic diagram illustrating a format of a sparse adjacency list (e.g., a sparse adjacency matrix), according to one or more embodiments of this specification. In the sparse adjacency matrix, each row corresponds to one primary graph node and each column corresponds to one of all graph nodes in a graph data partition. For example, assuming that the graph data partition includes n primary graph nodes and m mirror graph nodes, the sparse adjacency matrix is n×(n+m)-dimensional. For each primary graph node, if there is an edge between the primary graph node and one graph node in a column, corresponding edge data is stored at a location of a crossing matrix between the primary graph node and the graph node in the column. If there is no edge, corresponding edge data is 0. In this data storage manner, edge data is stored in units of primary graph nodes, thereby facilitating query of edge data based on the primary graph node.

In some embodiments, during graph data partitioning, partition offset information can also be generated for the graph data partition and stored in the graph data partition. The generated partition offset information includes the number of the primary graph nodes in the graph data partition. Positioning efficiency during partition positioning can be improved by using the partition offset information.

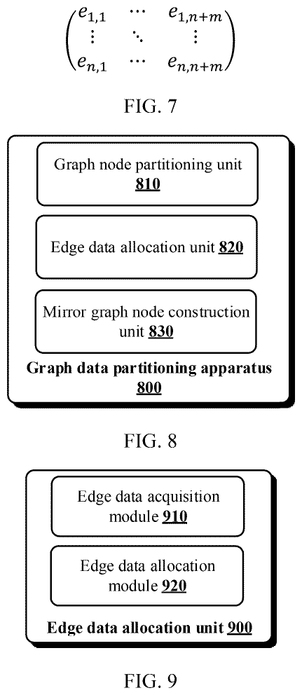

FIG. 8 is an example block diagram illustrating a graph data partitioning apparatus 800, according to one or more embodiments of this specification. As shown in FIG. 8, the graph data partitioning apparatus 800 includes a graph node partitioning unit 810, an edge data segmentation unit 820, and a mirror graph node construction unit 830.

The graph node partitioning unit 810 is configured to partition graph nodes in graph data based on degrees of the graph nodes according to a computing load balancing allocation algorithm, such that the graph nodes are partitioned as primary graph nodes into graph data partitions. For operations of the graph node partitioning unit 810, references can be made to the operations described above with reference to step 210 in FIG. 2.

The edge data allocation unit 820 is configured to allocate edge data of associated edges of the primary graph nodes to corresponding graph data partitions, where the associated edges can include outgoing edges and/or incoming edges. For operations of the edge data allocation unit 820, references can be made to the operations described above with reference to step 220 in FIG. 2.

The mirror graph node construction unit 830 is configured to construct, for an associated edge of a primary graph node, a replica of another graph node that corresponds to the primary graph node for the associated edge to be stored as a mirror graph node in a graph data partition corresponding to the primary graph node. For operations of the mirror graph node construction unit 830, references can be made to the operations described above with reference to step 230 in FIG. 2.

In some embodiments, the edge data allocation unit 820 can allocate edge data of associated edges of the primary graph nodes to the corresponding graph data partitions according to an associated edge allocation strategy, where the associated edge allocation strategy includes one of an outgoing edge allocation strategy, an incoming edge allocation strategy, or a combined outgoing edge/incoming edge allocation strategy. In some embodiments, the associated edge allocation strategy can be determined according to a graph data acquisition strategy of a downstream graph computing task.

FIG. 9 is an example block diagram of an edge data allocation unit 900, according to some embodiments of this specification. As shown in FIG. 9, the edge data allocation unit 900 includes an edge data acquisition module 910 and an edge data allocation module 920.

The edge data acquisition module 910 is configured to obtain edge data of the associated edges from an edge list of the graph data based on edge list offsets of the associated edges. For operations of the edge data acquisition module 910, references can be made to the operations described above with reference to step 610 in FIG. 6.

The edge data allocation module 920 is configured to allocate the obtained edge data of the associated edges to the corresponding graph data partitions. For operations of the edge data segmentation module 920, references can be made to the operations described above with reference to step 620 in FIG. 6.

In some embodiments, the graph data partitioning apparatus can further include a node number allocation unit. The node number allocation unit is configured to allocate local node identifiers and global node identifiers to the primary graph node in the graph data partition and the mirror graph node. In some embodiments, the graph data partitioning apparatus can further include a node mapping relationship establishment unit. The node mapping relationship establishing unit is configured to establish a node mapping relationship between the mirror graph node and a corresponding primary graph node in another graph data partition.

In some embodiments, the graph data partitioning apparatus can further include a partition offset information generation unit. The partition offset information generation unit is configured to generate partition offset information for the graph data partition and storing the partition offset information in the graph data partition, where the partition offset information includes the number of the primary graph nodes in the graph data partition.

With reference to FIG. 1 to FIG. 9, the graph data partitioning method and the graph data partitioning apparatus according to one or more embodiment of this specification have been described. The above-mentioned graph data partitioning apparatus can be implemented by using hardware, or can be implemented by using software or a combination of hardware and software.

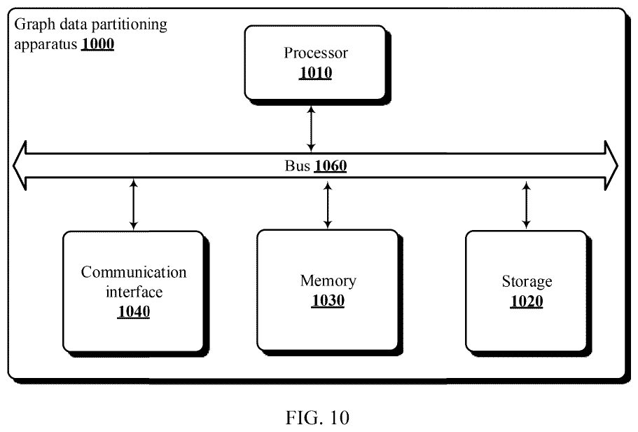

FIG. 10 is a schematic diagram illustrating a graph data partitioning apparatus 1000 implemented based on a computer system, according to one or more embodiments of this specification. As shown in FIG. 10, the graph data partitioning apparatus 1000 can include at least one processor 1010, a storage (e.g., a nonvolatile memory) 1020, a memory 1030, and a communication interface 1040, and the at least one processor 1010, the storage 1020, the memory 1030, and the communication interface 1040 are connected together through a bus 1060. The at least one processor 1010 executes at least one computer-readable instruction (i.e., the above-mentioned elements implemented in a software form) stored or encoded in the storage.

In one embodiment, a computer-executable instruction is stored in the storage, which, when executed, causes the at least one processor 1010 to: partition graph nodes in graph data based on degrees of the graph nodes according to a computing load balancing allocation algorithm, such that the graph nodes are partitioned as primary graph nodes into graph data partitions; allocate edge data of associated edges of the primary graph nodes to corresponding graph data partitions, where the associated edges include outgoing edges and/or incoming edges; and for an associated edge of a primary graph node, construct a replica of another graph node that corresponds to the primary graph node for the associated edge to be stored as a mirror graph node in a graph data partition corresponding to the primary graph node.

It should be understood that, when being executed, the computer-executable instruction stored in the storage enables the at least one processor 1010 to perform various operations and functions described above with reference to FIG. 1 to FIG. 9 in embodiments of this specification.

According to one embodiment, a program product such as a machine-readable medium (e.g., a non-transient machine-readable medium) is provided. The machine-readable medium can have an instruction (i.e., the above-mentioned elements implemented in a software form). When the instruction is executed by a machine, the machine is enabled to perform the above-mentioned operations and functions described with reference to FIG. 1 to FIG. 9 in embodiments of this specification. Specifically, a system or an apparatus equipped with a readable storage medium can be provided, and software program code for implementing the functions in any of the above-mentioned embodiments is stored in the readable storage medium, so that a computer or a processor of the system or the apparatus reads and executes the instruction stored in the readable storage medium.

In such case, the program code read from the readable medium can implement the functions in any one of some embodiments described above, and therefore the machine-readable code and the readable storage medium storing the machine-readable code form a part of this application.

Some embodiments of the readable storage medium include a floppy disk, a hard disk, a magneto-optical disk, an optical disc (for example, a CD-ROM, a CD-R, a CD-RW, a DVD-ROM, a DVD-RAM, a DVD-RW, and a DVD-RW), a magnetic tape, a nonvolatile memory card, and a ROM. Alternatively, the program code can be downloaded from a server computer or a cloud by a communication network.

According to one or more embodiments, a computer program product is provided. The computer program product includes a computer program, and when the computer program is executed by a processor, the processor is enabled to perform operations and functions described above with reference to FIG. 1 to FIG. 9 in embodiments of this specification.

A person skilled in the art should understand that various variations and modifications can be made to embodiments disclosed above without departing from the essence of this specification. Therefore, the protection scope of this specification should be defined by the appended claims.

It should be noted that, not all the steps and units in the above-mentioned processes and system structure diagrams are necessary, and some steps or units can be ignored based on an actual need. An order of performing the steps is not fixed, and can be determined based on a need. The apparatus structure described in the above-mentioned embodiments can be a physical structure or a logical structure. In other words, some units can be implemented by the same physical entity, or some units can be implemented by a plurality of physical entities, or can be implemented together by some components in a plurality of independent devices.

In the above-mentioned embodiments, a hardware unit or module can be implemented mechanically or electrically. For example, a hardware unit, a module, or a processor can include a permanent dedicated circuit or logic (e.g., a dedicated processor, FPGA, or ASIC) to complete a corresponding operation. The hardware unit or the processor can further include a programmable logic or circuit (e.g., a general-purpose processor or another programmable processor), and can be set temporarily by software to complete a corresponding operation. Specific implementations (mechanical methods, dedicated permanent circuits, or temporarily disposed circuits) can be determined based on cost and time considerations.

The specific implementations illustrated above with reference to the accompanying drawings describe example embodiments, but do not represent all embodiments that can be implemented or fall within the protection scope of the claims. The term “example” used throughout this specification means “used as an example, an instance, or an illustration” and does not mean “preferred” or “advantageous” over other embodiments. Specific implementations include specific details for the purpose of providing an understanding of the described technologies. However, these technologies can be implemented without these specific details. In some instances, to avoid obscuring the described concepts in the embodiments, well-known structures and apparatuses are shown in the form of a block diagram.

The above-mentioned descriptions of this disclosure are provided to enable any person of ordinary skill in the art to implement or use this disclosure. Various modifications made to this disclosure are apparent to a person of ordinary skill in the art, and the general principles defined in this specification can also be applied to other variants without departing from the protection scope of this disclosure. Therefore, this disclosure is not limited to the examples and designs described in this specification, but corresponds to the widest scope of principles and novel features disclosed in this specification.

What is claimed is:

1. A method for graph data partitioning, comprising:
partitioning graph nodes in graph data based on degrees of the graph nodes according to a computing load balancing allocation algorithm, such that the graph nodes are partitioned as primary graph nodes into graph data partitions;
allocating edge data of associated edges of the primary graph nodes to corresponding graph data partitions, wherein the associated edges comprise at least one of outgoing edges or incoming edges; and
for an associated edge of a primary graph node, constructing a replica of another graph node that corresponds to the primary graph node for the associated edge to be stored as a mirror graph node in a graph data partition corresponding to the primary graph node.

2. The method according to claim 1, wherein the allocating the edge data of the associated edges of the primary graph nodes to the corresponding graph data partitions comprises:
allocating edge data of the associated edges of the primary graph nodes to the corresponding graph data partitions according to an associated edge allocation strategy, wherein the associated edge allocation strategy comprises one of an outgoing edge allocation strategy, an incoming edge allocation strategy, or a combined outgoing edge and incoming edge allocation strategy.

3. The method according to claim 2, wherein the associated edge allocation strategy is determined according to a graph data acquisition strategy of a downstream graph computing task.

4. The method according to claim 1, wherein the allocating the edge data of the associated edges of the primary graph nodes to the corresponding graph data partitions comprises:
obtaining edge data of the associated edges from an edge list of the graph data based on edge list offsets of the associated edges; and
allocating the edge data of the associated edges to the corresponding graph data partitions.

5. The method according to claim 4, wherein the edge data is stored in the edge list in an order of node numbers of corresponding graph nodes, and the edge list offsets of the associated edges are determined based on out-degrees of the graph nodes.

6. The method according to claim 1, further comprising at least one of:
allocating local node identifiers and global node identifiers to the primary graph node in the graph data partition and the mirror graph node; or establishing a node mapping relationship between the mirror graph node and a corresponding primary graph node in another graph data partition.

7. The method according to claim 1, wherein an edge list of the edge data is in a format of a sparse adjacency list.

8. The method according to claim 1, further comprising:
generating partition offset information for the graph data partition; and
storing the partition offset information in the graph data partition, wherein the partition offset information comprises the number of primary graph nodes in the graph data partition.

9. A computer-implemented device, comprising:
one or more processors; and
one or more computer memory devices interoperably coupled with the one or more processors and having tangible, non-transitory, machine-readable media storing one or more instructions that, when executed by the one or more processors, perform one or more operations comprising:
partitioning graph nodes in graph data based on degrees of the graph nodes according to a computing load balancing allocation algorithm, such that the graph nodes are partitioned as primary graph nodes into graph data partitions;
allocating edge data of associated edges of the primary graph nodes to corresponding graph data partitions, wherein the associated edges comprise at least one of outgoing edges or incoming edges; and
for an associated edge of a primary graph node, constructing a replica of another graph node that corresponds to the primary graph node for the associated edge to be stored as a mirror graph node in a graph data partition corresponding to the primary graph node.

10. The computer-implemented device according to claim 9, wherein the allocating the edge data of the associated edges of the primary graph nodes to the corresponding graph data partitions comprises:
allocating edge data of the associated edges of the primary graph nodes to the corresponding graph data partitions according to an associated edge allocation strategy, wherein the associated edge allocation strategy comprises one of an outgoing edge allocation strategy, an incoming edge allocation strategy, or a combined outgoing edge and incoming edge allocation strategy.

11. The computer-implemented device according to claim 9, wherein the allocating the edge data of the associated edges of the primary graph nodes to the corresponding graph data partitions comprises:
obtaining edge data of the associated edges from an edge list of the graph data based on edge list offsets of the associated edges; and
allocating the edge data of the associated edges to the corresponding graph data partitions.

12. The computer-implemented device according to claim 9, wherein the one or more operations further comprise at least one of:
allocating local node identifiers and global node identifiers to the primary graph node in the graph data partition and the mirror graph node; or
establishing a node mapping relationship between the mirror graph node and a corresponding primary graph node in another graph data partition.

13. The computer-implemented device according to claim 9, wherein an edge list of the edge data is in a format of a sparse adjacency list.

14. The computer-implemented device according to claim 9, wherein the one or more operations further comprise:
generating partition offset information for the graph data partition; and
storing the partition offset information in the graph data partition, wherein the partition offset information comprises the number of primary graph nodes in the graph data partition.

15. A non-transitory, computer-readable medium storing one or more instructions executable by a computer system to perform operations comprising:
partitioning graph nodes in graph data based on degrees of the graph nodes according to a computing load balancing allocation algorithm, such that the graph nodes are partitioned as primary graph nodes into graph data partitions;
allocating edge data of associated edges of the primary graph nodes to corresponding graph data partitions, wherein the associated edges comprise at least one of outgoing edges or incoming edges; and
for an associated edge of a primary graph node, constructing a replica of another graph node that corresponds to the primary graph node for the associated edge to be stored as a mirror graph node in a graph data partition corresponding to the primary graph node.

16. The non-transitory, computer-readable medium according to claim 15, wherein the allocating the edge data of the associated edges of the primary graph nodes to the corresponding graph data partitions comprises:
allocating edge data of the associated edges of the primary graph nodes to the corresponding graph data partitions according to an associated edge allocation strategy, wherein the associated edge allocation strategy comprises one of an outgoing edge allocation strategy, an incoming edge allocation strategy, or a combined outgoing edge and incoming edge allocation strategy.

17. The non-transitory, computer-readable medium according to claim 15, wherein the allocating the edge data of the associated edges of the primary graph nodes to the corresponding graph data partitions comprises:
obtaining edge data of the associated edges from an edge list of the graph data based on edge list offsets of the associated edges; and
allocating the edge data of the associated edges to the corresponding graph data partitions.

18. The non-transitory, computer-readable medium according to claim 15, wherein the operations further comprise at least one of:
allocating local node identifiers and global node identifiers to the primary graph node in the graph data partition and the mirror graph node; or
establishing a node mapping relationship between the mirror graph node and a corresponding primary graph node in another graph data partition.

19. The non-transitory, computer-readable medium according to claim 15, wherein an edge list of the edge data is in a format of a sparse adjacency list.

20. The non-transitory, computer-readable medium according to claim 15, wherein the operations further comprise:
generating partition offset information for the graph data partition; and
storing the partition offset information in the graph data partition, wherein the partition offset information comprises the number of primary graph nodes in the graph data partition.
